(19) United States
(12) Patent Application Publication
(10) Pub. No.: US 2019/0322059 A1
(43) Pub. Date: Oct. 24, 2019

(54) METHOD AND SYSTEM FOR FABRICATION OF COMPOSITE PREFORMS

(71) Applicant: Seriforge, Inc., San Francisco, CA (US)

(72) Inventors: Ashish A Choudhari, San Francisco, CA (US); Eric Gregory, San Francisco, CA (US); Gregory E. James, San Francisco, CA (US); Jonathan Worthy Hollander, San Francisco, CA (US)

(73) Assignee: Seriforge, Inc., San Francisco, CA (US)

(21) Appl. No.: 16/388,601

(22) Filed: Apr. 18, 2019

Related U.S. Application Data
(60) Provisional application No. 62/660,557, filed on Apr. 20, 2018.

(51) Int. Cl. B29C 70/34; B29C 70/54

(52) U.S. Cl. CPC B29C 70/342; B29C 70/541

(57) ABSTRACT

Implementations include a system including a preform fabrication apparatus and method for creating composite preforms through a process of determining a preform shape and number of layers required to assemble the preform and using a preform layer assembly apparatus to provide a number of functions such as receiving and holding a composite layer, shaping the composite layer, pressing composite layer onto a preform support structure, forming the composite layer into a preform shape, etc. Multiple composite layers may be picked up, held, shaped, and applied to a preform by the assembly apparatus. The assembly apparatus includes a flexible membrane settable to a deformable shape and a rigid state such that flexible membrane may be configured to be deformed into an assembly shape, which is then held in a rigid state. The flexible membrane may be used to apply pressure to an article to conform the article to the assembly shape.

### CROSS REFERENCES TO RELATED APPLICATIONS

This application claims the benefit of U.S. Provisional Patent Application Ser. No. 62/660,557, entitled METHOD AND SYSTEM FOR FABRICATION OF COMPOSITE PREFORMS, filed on Apr. 20, 2018, which is hereby incorporated by reference as if set forth in full in this application for all purposes.

### BACKGROUND

The present invention relates to the field of fiber-reinforced composite materials, and in particular to methods and devices for manufacturing composite preforms and finished composite products with complicated three-dimensional shapes.

Fiber-reinforced composite materials, referred to herein as composites, are materials comprised of fibers embedded in a matrix material. Typical fibers include but are not limited to glass fibers, carbon fibers (e.g. graphite fibers and/or more exotic forms of carbon, such as carbon nanotubes), ceramic fibers, and synthetic polymer fibers, such as aramid and ultra-high-molecular-weight polyethylene fibers. Typical matrix materials include polymers, such as epoxies, vinylesters, polyester thermosetting plastics, phenol formaldehyde resins, cement, concrete, metals, ceramics, and the like.

Composite materials often combine high-strength and relatively low weight. In typical composite products, the fibers provide high tensile strength in one or more directions and the matrix material hold the fibers in a specific shape. A set of fibers roughly in the shape of a final product is referred to as a composite preform. Typical prior composite preforms are comprised of layers of fibers, which are often woven or bound into a sheet of fabric that are cut and arranged into a desired shape. Because fibers and fabrics made from fibers only provide high strength in specific directions, multiple layers of fiber cloth are often stacked in different orientations to provide strength and stiffness optimized for the intended usage of the final product.

Most prior composite manufacturing techniques require the production of some type of mold, mandrel, plug, or other rigid structure in the shape of the desired preform. Sheets of fiber fabric are then cut and arranged on this rigid structure. A matrix material, such as uncured polymer resin, may be embedded in the fiber fabric or applied to the fabric during or after the fabric layup process. The matrix material is then cured or hardened, often under elevated temperature and/or pressure differentials to ensure even distribution of the matrix material and prevent voids, air bubbles, or other internal defects. Pressure and/or temperature may be applied to the composite part during curing using techniques including compression molding, vacuum bags, autoclaves, inflatable bladders, and/or curing ovens, etc.

Unfortunately, prior techniques for manufacturing composite preforms and final composite parts, especially for complex part shapes, are time-consuming and difficult to automate. For example, creating a mold, mandrel, or other rigid structure for supporting the preform is costly and time-consuming, especially for custom parts or small production runs where the tooling cost and time cannot be amortized over a large number of parts. Moreover, the cutting and/or arranging fabric in the mold or other rigid structure is often performed by hand, due to the difficulty in draping fabric over complex forms without wrinkles or other surface defects. As a result, composite products are much more expensive than equivalent products made using conventional materials.

Therefore, what is needed is a fabrication apparatus and method for manufacturing composite preforms and final composite parts that overcomes the limitations of the prior art.

### BRIEF DESCRIPTION OF THE DRAWINGS

Implementations will be described with reference to the drawings, in which:

FIGS. 1A and 1B illustrate a fabrication apparatus for manufacturing composite preforms according to implementations described herein.

FIG. 2A-C is a high-level illustration of a preform layer assembly apparatus used in manufacturing composite preforms and finished composite products with complicated three-dimensional shapes for use with implementations described herein.

FIGS. 3A-B are high-level illustrations of a preform layer assembly apparatus and process used in assembling layers for composite preforms with complicated three-dimensional shapes for use with implementations described herein.

FIGS. 4A-K are high-level illustrations of a preform layer assembly apparatus and process used in assembling layers for composite preforms with complicated three-dimensional shapes for use with implementations described herein.

FIGS. 5A-B are high-level illustrations of composite preform layer stacking using a preform fabrication apparatus for use with implementations described herein.

FIG. 6 is a high-level flow diagram for a method of manufacturing composite preforms with complicated three-dimensional shapes for use with implementations described herein.

FIGS. 7A-C illustrates example composite preform or finished products manufactured using systems and methods implementations described herein.

FIG. 8 illustrates a computer system suitable for controlling a system for three-dimensional assembly of composite preforms and products with varying cross-sectional topology according to implementations described herein.

### SUMMARY

Implementations include a system including a preform fabrication apparatus and method for creating composite preforms through a process of determining a preform shape and number of layers required to assemble the preform and using a preform layer assembly apparatus to provide a number of functions such shaping the composite layer, pressing composite layer onto a preform support structure, forming the composite layer into a preform shape, etc. Multiple composite layers may be shaped, and applied to a preform by the assembly apparatus. The assembly apparatus includes a flexible membrane settable to a deformable shape and a rigid state such that flexible membrane may be configured to be deformed into an assembly shape, which is then held in a rigid state. The flexible membrane may be used to apply pressure to an article to conform the article to the assembly shape.

In some implementations the assembly apparatus is configured to change from a flexible state to a rigid state in order to press layers into a tool, such as a mold or fixture, and to conform the layers to the shape of the tool. During the pressing process, the assembly apparatus may be configured to relax its shape sufficiently to conform its shape and the shape of the composite layer to the surface receiving the composite layer.

In another implementation, the assembly apparatus includes a flexible membrane attached to suction or other type of atmosphere evacuation device. The flexible membrane may be configured into a flexible chamber and at least partially filled with a shape resettable material. The shape resettable material may virtually any granular material composed of fragments, such as sand, and the like, that can be held via internal friction between the fragments. During a hold configuration a vacuum may be drawn in the flexible chamber. The flexible chamber may be configured to collapse around the fragments which when pressed together hold a fixed shape due to frictional forces between the fragments.

In some embodiments, before the vacuum is drawn, the flexible chamber may be pressed against a composite layer. This causes the flexible chamber to conform to the shape of the composite layer and the underlying tool. Then, an additional composite layer and flexible membrane may be pressed against a receiving surface for depositing the composite layer thereon. During the depositing process, the flexible chamber vacuum may be released in order to release the friction between the fragments to allow the flexible chamber to become flexible in order to uniformly press the composite layer over the receiving surface.

In other implementations, the flexible chamber holding a layer may be pressed on a proxy surface and then vacuum applied to fix the chamber shape according to the surface of the proxy surface in order to deform the composite layer into a preform shape prior to applying the composite layer to a preform surface.

In some implementations, the flexible chamber and/or flexible surface may be heated or cooled in order to accommodate different preform layer assembly processes, such as making a layer more malleable or binding a layer to a tool or previously formed layers. Further, the flexible membrane may have channels or other elements embedded therein to allow for the heat and cooling. In addition, the flexible membrane may include a series of holes and/or other types of dispensing formations or assemblies used to allow flexible membrane to excrete liquids such as adhesives, bonding agents, insulation, liquid layers, etc.

In implementations, two or more assembly apparatuses are used to secure and press preform parts together during a preform assembly process.

### DETAILED DESCRIPTION

Implementations include a system including a preform fabrication apparatus and method for creating composite preforms through a process of determining a preform shape and number of layers required to assemble the preform and using a preform layer assembly apparatus to provide a number of functions such as, shaping the composite layer, pressing composite layer onto a preform support structure, forming the composite layer into a preform shape, etc. Multiple composite layers may be applied to a preform by the assembly apparatus. The assembly apparatus includes a flexible membrane settable to a deformable shape and a rigid state such that flexible membrane may be configured to be deformed into an assembly shape, which is then held in a rigid state. The flexible membrane may be used to apply pressure to an article to conform the article to the assembly shape.

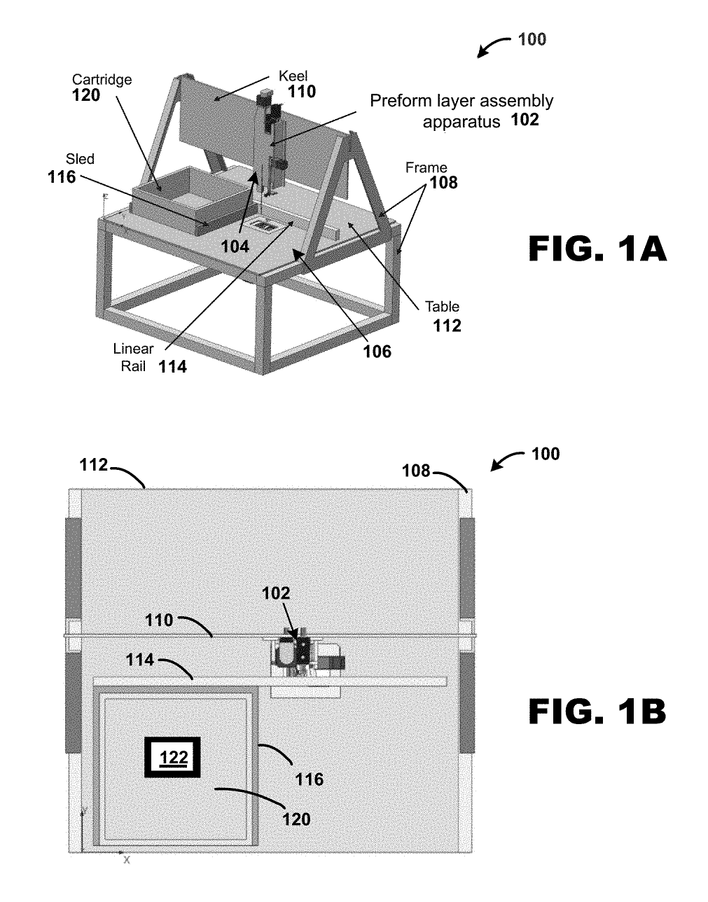

FIG. 1A is a perspective view and FIG. 1B is a top view illustrating a fabrication apparatus 100 for automated fabrication of composite preforms. In one implementation, fabrication apparatus 100 includes an assembly apparatus 102 supported by frame 108 and a motion stage 106. Motion stage 106 includes keel 110, table 112, and linear rail 114, which are connected to frame 108. Keel 110 may be configured to support assembly apparatus 102. Table 112 may be configured to support a sled 116 adapted to receive a preform 118, and other items such as cartridge 120, configured to hold a tool 122 such as a mold, proxy shape, and the like, as described herein.

As described herein, fabrication apparatus may be controlled by software such as CAD/CAM Software, embedded machine software, and the like. In an implementation, motion stage 106 is configured to move the composite preform relative to preform layer assembly apparatus 102 in order to create different layering patterns used to layer layers of fabric together forming the composite preforms.

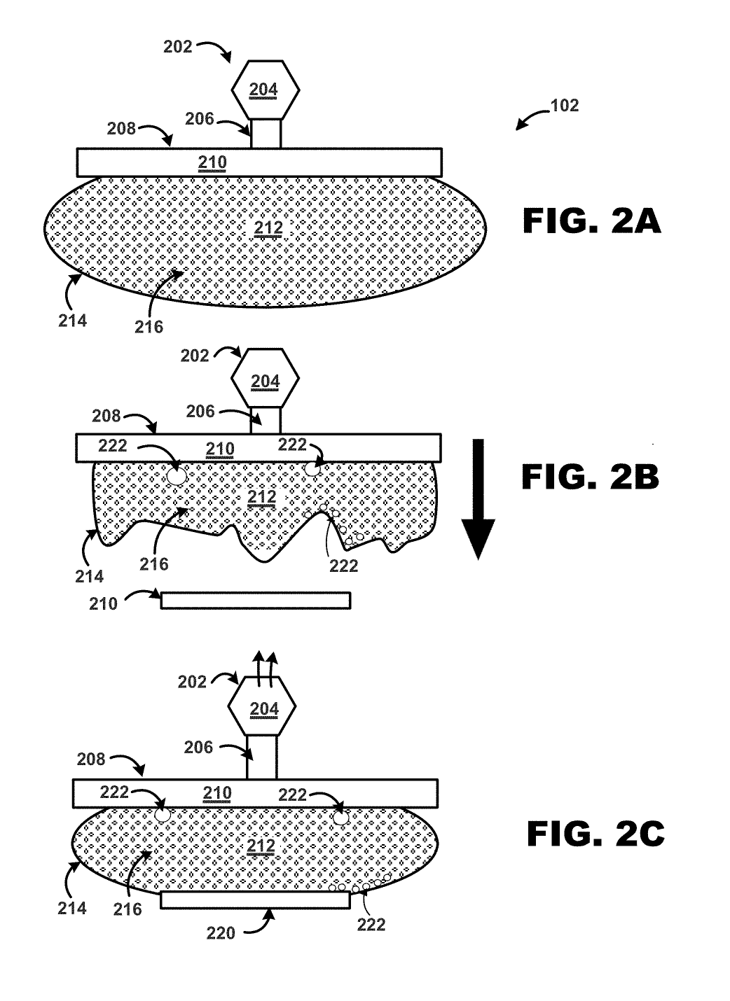

FIG. 2A-C is a high-level illustration of an assembly apparatus 102 used in manufacturing composite preforms and finished composite products with complicated three-dimensional shapes for use with implementations described herein. In implementations, assembly apparatus 102 may include an upper portion 202 that includes or is coupled to a vacuum source 204, coupled to port 206, and chamber 208. Chamber 208 may be composed of an upper support structure 210, and a lower flexible portion 212 composed of flexible membrane 214, such as rubber, cloth, and the like, configured to hold at least a partial vacuum. Flexible membrane 214 may be virtually any material that is flexible and prevents the passing of gas through the material within a threshold rate. For example, flexible membrane 214 may be a dense rubber material that prevents the passing of gas, such as air, or a mixture thereof, at a rate low enough to hold a vacuum when the flexible membrane is formed into a shape, such as a balloon shape.

Lower flexible portion 212 may be configured as a chamber filled with granular materials 216, such as ground coffee, sand, and the like, that remain loose when not held together but form a rigid body when presses together due to internal friction. Materials 216 may include preformed interlocking materials that are configured to lock together when pressed into a shape by external forces.

As illustrated in FIG. 2B, lower flexible portion 212 may be placed into a flexible deformable state for use in assembly functions such depositing objects onto another surface, put pressure onto objects, such as composite layers, etc. For example, as illustrated in a FIG. 2A, lower flexible portion 212 may be filled with a gas, such as air, until flexible membrane 214 reaches a uniform shape and ductility. As further illustrated in FIG. 2B, gas may be removed, for example, by vacuum source 204, such that lower flexible chamber 212 is in a second state used for picking up an article 220, such as a composite layer via frictional contact between flexible membrane 214 and article 220. Lower flexible portion 212 may also be expanded in size, for example, via internal pressure, to act as a flexible pushing mechanism configured to apply a flexible surface as a jamming membrane to apply force to objects.

As illustrated in FIG. 2C, lower flexible portion 212 may be configured with sufficient ductility such that flexible membrane 214 is deformable and flows around edges of article 220. Lower flexible portion 212, may be configured to a rigid state using material 212, by applying a vacuum from vacuum source 204 through port 206, which is configured to draw a vacuum by drawing gas out of lower flexible portion 212 until materials 216 are compressed together.

In implementations, once a vacuum is pulled, external forces, such as atmospheric pressure, press on lower flexible portion 212 until material 216 is pressed together in a rigid shape held together by forces, such as frictional forces, magnetic forces, adhesive forces, and the like between individual components of materials 216. Once set into a rigid shape, lower flexible portion 212 may hold article 220 via frictional and/or interlocking mechanical contact between material 216 and article 220.

Alternatively, for articles that may need to be physically stabilized during pressing, lower flexible portion 212 may be configured to hold article 220 by frictional and/or grip contact with edges and structures of article 220. If the article is too thin or fragile to hold via friction or grip for example, flexible membrane 214 of lower flexible portion 212 may be configured to allow other types of forces to hold article 216. As such, flexible membrane 214 may be configured to be semi-permeable to allow suction, such as from vacuum source 204, to hold article 220 against flexible membrane 214. Alternatively, article 220, such as fabric layers, may also be clamped at sides or corners to springs or elastic members during pressing.

In exemplary implementations, lower flexible portion 212 may include heating and/or cooling elements 222 to allow heat and/or cold to be applied to article 220. For example, lower flexible portion 212 may include elements 222 such as electrical heating elements, tubes or cavities for hot or cold fluids, and the like, that may be used to apply heat and/or cooling to article 220 via flexible membrane 214.

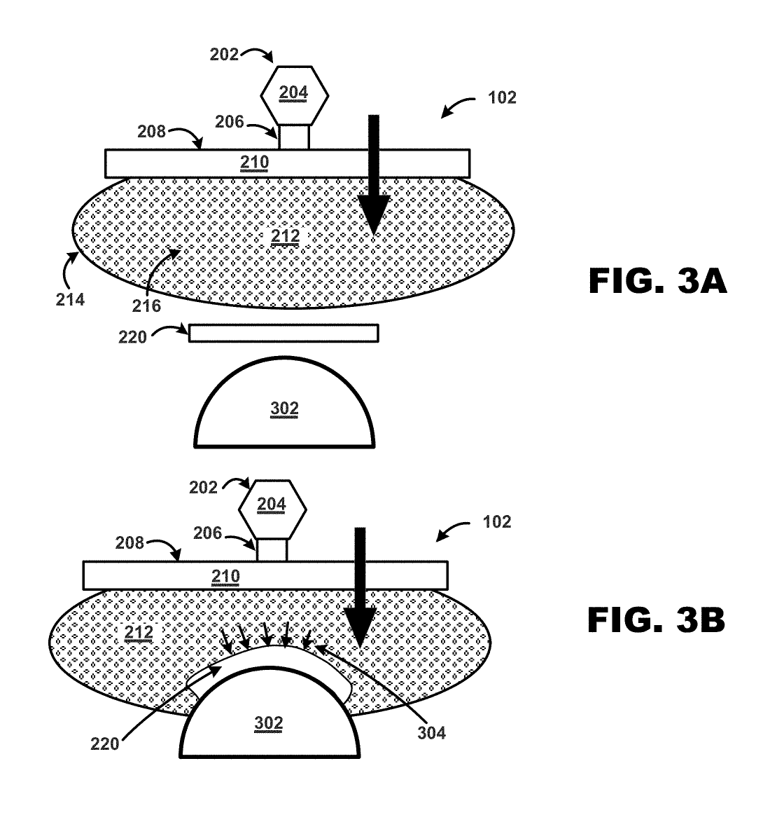

FIGS. 3A-B are high-level illustrations of a preform layer assembly apparatus 102 and process used in assembling layers for composite preforms with complicated three-dimensional shapes for use with implementations described herein. As illustrated in FIGS. 3A-B, assembly apparatus 102 may be configured to hold pressure, which may be used to provide external pressure on another surface.

For example, as illustrated in FIG. 3A, preform layer assembly apparatus 102 is held distal from article 210 and surface 302. As shown in FIG. 3B, layer assembly apparatus 102 may be employed to put force on article 220 to press article 220 against surface 302. In one implementation, lower flexible portion 212 may be set in a first flexible state configured to press and conform article 220 onto surface 302. In addition, to apply additional conforming pressure, as force is applied to assembly apparatus 102, material 216 may be placed into a further rigid state to apply further pressure in order to place additional application pressure from lower flexible portion 212 to article 220.

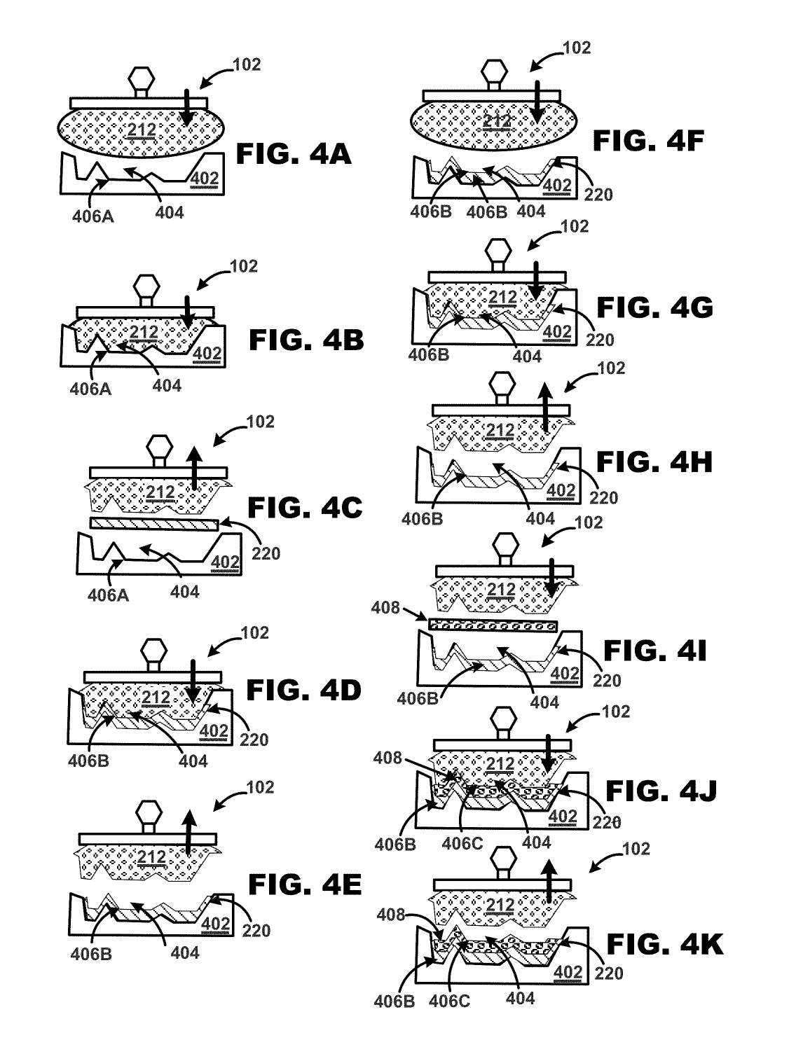

FIGS. 4A-K are high-level illustrations of a preform layer assembly apparatus 102 and process used in assembling layers for composite preforms with complicated three-dimensional shapes for use with implementations described herein. In one implementation, assembly apparatus 102 may be employed to take the shape of a preform mold or surface, and then use the shape to press an article, such as a preform composite layer, onto the mold or surface.

For example, as illustrated in FIG. 4A, assembly apparatus 102 may be configured to capture a shape, and then use that shape to apply and press an article, e.g., composite layer to a surface of a preform mold 402. In this example, lower flexible portion 212 may be set to a deformable state whereby, as shown in FIG. 4B, the lower flexible portion 212 is pressed into preform mold 402, taking the shape thereof due to its deformability. At this juncture, lower flexible portion 212 may be set to a rigid forming shape as described herein, for example, by drawing a vacuum on lower flexible portion 212 compressing materials 214 contained therein.

As illustrated in FIG. 4C, once the desired shape is set, the lower flexible portion 212 may be removed from mold 402, and an article 220 may be placed between the assembly apparatus 102 and preform mold 402.

As illustrated in FIG. 4D, assembly apparatus 102 may be positioned to move toward mold 402 such that lower flexible portion 212 presses against article 402 applying pressure to article 220, and pressing article 220 onto a surface 406A of cavity 404 of preform mold 402. An upper surface of Article 220 forms layer 406B of cavity 404. As illustrated in FIG. 4E, assembly apparatus 102 may be moved away from mold 402 leaving layer 406B formed by the forming shape of reshaped article 220.

In some implementations, to add additional layers, flexible portion 212 may be reconfigured to the forming shape of an added layer, such as layer 406B. For example, as illustrated in FIGS. 4E and 4F, since layer 406B partially fills mold 402, a surfaced of layer 406B forms a new surface of mold 402 with a slightly different shape than surface 406A.

As shown in FIG. 4G, similar to applying layer 406B as discussed, assembly apparatus 102 may be moved toward mold 402 such when flexible portion 212 of assembly apparatus 102 is pushed into cavity 404, flexible portion 212 takes on the shape of the new surface formed by layer 406B. When the new forming shape is obtained, as illustrated in FIGS. 4H and 41, assembly apparatus 102 may be separated from mold 402 in order to place a new layer 408 between assembly apparatus 102 and mold 402 having layer 406B.

As illustrated in FIG. 4J, assembly apparatus 102 may be positioned to move toward mold 402 such that lower flexible portion 212 presses against article 408, pressing article 408 onto surface 406A. Once applied, article 408 forms layer 406C of cavity 404. As illustrated in FIG. 4J, assembly apparatus 102 may be moved away from mold 402 leaving layer 406C formed by the reshaped article 408 disposed upon layer 406A. As illustrated in FIG. 4K, assembly apparatus 102 may be separated from mold 420 in order to place another layer, structure, and the like, between assembly apparatus 102 and mold 402.

In some implementations, this process may be repeated to build a preform. For example, other articles and/or structures may be added in a similar fashion by shaping and reshaping lower flexible portion 212.

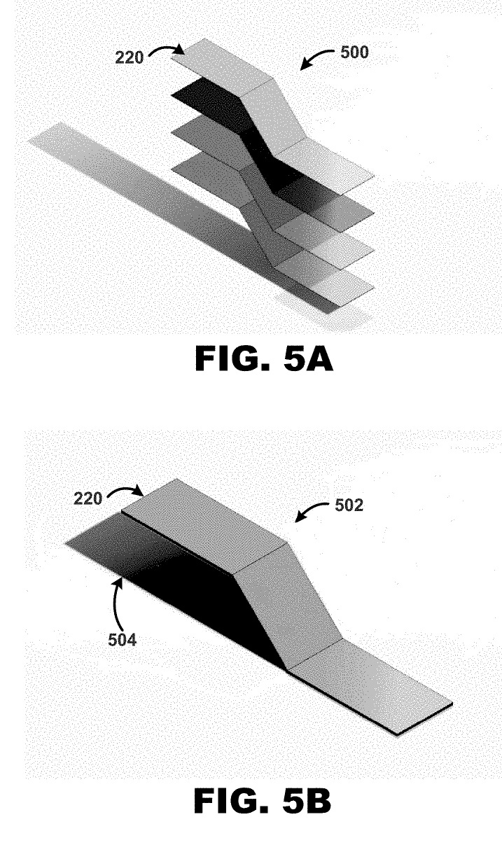

It is contemplated that any number and configuration of layers and structures, such as layers 406A and 406B, may be added to form various configurations of a preform. In one example, layers 406 may be partial layers that allow internal structures, cavities, and the like, to be built using assembly apparatus 102. Several different layer 406 configurations may be added that form a structure within cavity 404. For example, as illustrated in FIGS. 5A-B, lower flexible portion 212 may be employed to deposit several layers onto a shaping surface 504, such as surface 302, surface 406A of mold 402, and the like.

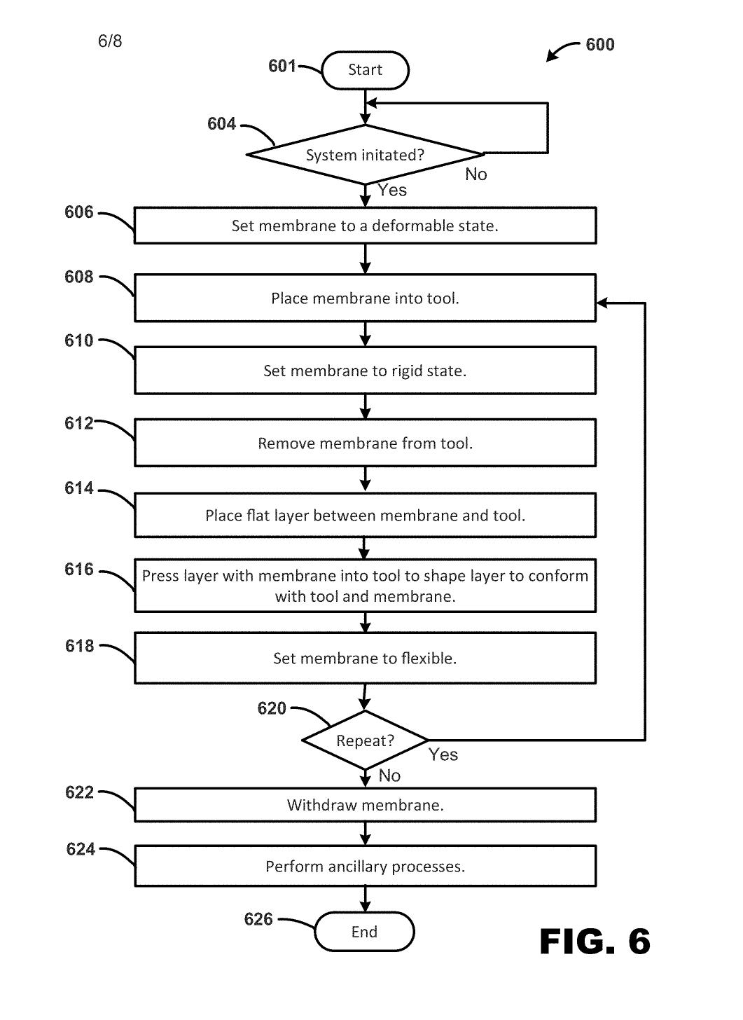

FIG. 6 is a high-level flow diagram for a method 600 of manufacturing composite preforms and finished composite products with complicated three-dimensional shapes for use with implementations herein. In one implementation, at 604 when method 600 is invoked, for example, when a preform fabrication is initiated. At 602, method 600 determines whether a preform fabrication system, such as fabrication apparatus 100, has been initiated. If so, method proceeds to 606. If not, method 600 returns to 604.

In one implementation, at 606, method 600 sets a membrane to a deformable state. For example, assembly apparatus 102 may be set such that flexible portion 212 is deformable and/or configured in a shape to press an article 220 such as a composite layer, structure, and the like against another surface.

At 608, method 600 places membrane into a tool. For example, as illustrated in FIGS. 4A-K, flexible portion 212 is placed into a tool, such as mold 402.

At 610, once flexible portion 212 is deformed by the tool, method 600 sets the membrane to a rigid state. For example, as illustrated in FIGS. 3B and in FIGS. 4A-K, method 600 may set assembly apparatus 102 such that flexible portion 212 is set to a deformable shape and pressed into a mold 402 or other tool to deform a contact surface of flexible portion 212 into a desired rigid pushing shape. Further at 610, method 600 then sets the flexible portion 212 to the rigid state.

Once the flexible membrane has been deformed to the shape of the tool and set to a rigid state, method 600 applies pressure to an article, e.g., a flat material layer, placed between the membrane and the tool to deform the article to the shape of the tool and place it within the tool.

In one implementation at 612, the flexible portion 212, previously deformed to the tool shape and in the rigid state, is withdrawn from the tool. A flat article, such as a fabric layer, is placed over tool and the flexible portion 212 is then reinserted into the tool. Because the flexible portion 212 is deformed to the shape of the tool and is in the rigid state, the flexible portion 212 acts a press to push the article into the tool and form it into the tool shape. For example, as illustrated in FIG. 4C, flexible portion 212 pushes article 220 into mold 402 to confirm article 220 to the shape of mold 402.

In another implementation, at 612, the tool used for deforming the membrane, e.g., flexible portion 212, is different than a second tool used for holding the article after forming. In this implementation, at 612 method 600 moves the flexible membrane 612 to the second tool and presses the article into the second tool.

In yet another implementation, steps 608-616 may be performed simultaneously. In this implementation, an article is placed between the flexible membrane 212 and a tool. The flexible membrane 212 is set to a deformable state and inserted into the tool, deforming both itself and the article to the shape of the tool. The flexible membrane may then be set to a rigid state to apply further pressing force.

At 616, method 600 may vary the pressing pressure and temperature to assist with deforming the article to the tool shape, binding the article to one or more previously pressed articles, and/or consolidating and curing the article and any previously pressed articles into a finished part. For example, at 616 method 600 may heat the article to make it more malleable and then cooling it to set this shape, heat the article to activate a binder or adhesive applied to the article and/or the previously-pressed article, and/or use heat and/or pressure to initiate resin flow and curing within and between the article and any previously placed articles.

At 620, method 600 checks to see if assembly processing is finished. If so, method 600 proceeds to 622. At 622, method 600 removes the membrane from the tool. In one implementation, the membrane is set to a deformable state prior to being removed from the tool. In another implementation, at 622, method 600 removes the flexible membrane from the tool in the rigid state and then at returns it to the deformable state.

If the assembly process is not complete, method 600 proceeds from 620 to 608, so that 608-618 are repeated for one or more additional articles.

Following 622, at 624, method 600 performs any ancillary assembly processes, such as molding the part within the tool or a different tool, machining or cutting the part or preform, and/or installing hardware such as fasteners or inserts prior to or subsequent to molding. At 626, method 600 ends.

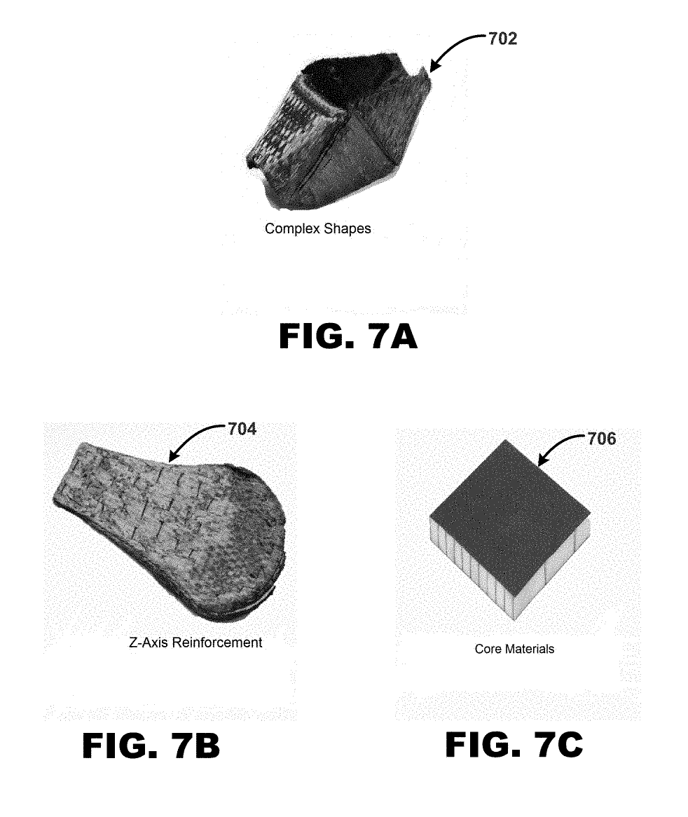

FIGS. 7A-C illustrates example composite preform or finished products manufactured using systems and methods implementations described herein. For example, assembly apparatus 100 may be used to develop complex shapes, as illustrated in FIG. 7A, Z-axis reinforcement, as illustrated in FIG. 7B, and core materials, such as illustrated in FIG. 7C.

In other implementations, two or more assembly apparatuses 102 may be configure such that flexible portions 212 of respective assembly apparatuses 102 can hold and process a preform at the same time. For example, one assembly apparatus may be used to hold a preform while another assembly apparatus 102 may be used to apply layers, structures, etc. to the preform being held by the other assembly apparatus 102.

In some implementations, a plurality of assembly apparatuses 102 may be configured for multiple uses such as holding and passing preforms, articles, etc., along a process path, adding layers, applying heat and/or cold to preforms, etc. For example, a plurality of assembly apparatuses 102 may be used to hold and move a preform along a processing path and do other assembly processes, such as adding layers, etc. to the preform. As such, assembly apparatus 102 may be configured to perform a multitude of assembly and manufacturing tasks.

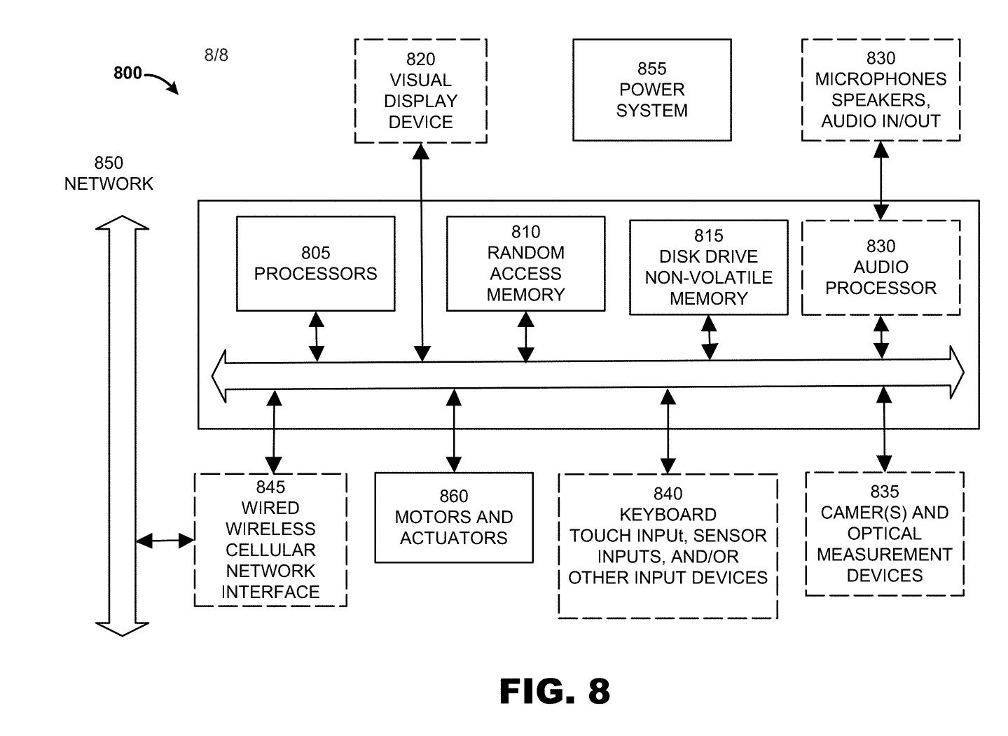

FIG. 8 illustrates a computer system suitable 800 for controlling a system for three-dimensional weaving of composite preforms and products with varying cross-sectional topology according to implementations described herein. The computer system 800 includes one or more general purpose or specialized processors 805, which can include microprocessors, microcontrollers, system on a chip (SoC) devices, digital signal processors, graphics processing units (GPUs), ASICs, FPGAs and other programmable logic devices, and other information processing devices. The computer system 800 also includes random access memory 810 and non-volatile memory 815, such as a magnetic or optical disk drive and/or flash memory devices.

The computer system 800 may optionally include one or more visual display devices 820. The computer system 800 may also optionally include an audio processor 825 for generating and receiving sound via speakers, microphone, or other audio inputs and outputs 830; and optional sensors and input devices 840 such as keyboards; scroll wheels; buttons; keypads; touch pads, touch screens, and other touch sensors; joysticks and direction pads; motion sensors, such as accelerometers and gyroscopes; global positioning system (GPS) and other location determining sensors; temperature sensors; such as mechanical, optical, magnetic or other types of position detectors and/or limit switches for detecting the current positions of the various components of the above-described systems; voltage, current, resistance, capacitance, inductance, continuity, or any other type of sensor for measuring electrical characteristics of the various components of the above-described systems; force, acceleration, stress or strain, and/or tension sensors; and/or any other type of input device known in the art. Computer system 800 may optionally include one or more cameras or other optical measurement devices 835 for capturing still images and/or video.

The computer system 800 may also include one or more modems and/or wired or wireless network interfaces 845 (such as the 802.11 family of network standards) for communicating data via local-area networks 850; wide-area networks such as the Internet; CDMA, GSM, or other cellular data networks of any generation or protocol; industrial networks; or any other standard or proprietary networks. The computer system 800 can also include a peripheral and/or data transfer interface, such as wired or wireless USB, IEEE 1394 (Firewire), Bluetooth, or other wired or wireless data transfer interfaces.

The computer system 800 can include a power system 855 for obtaining electrical power from an external source, such as AC line current or DC power tailored to the computer system 800 via an external power supply, as well as one or more rechargeable or one-time use batteries, fuel cells, or any other electrical energy generation device. Additionally, power system 855 may provide energy in the form of compressed gas, vacuum, and/or hydraulic systems to power various actuators and components of embodiments of the invention.

Computer system 800 may be implemented in a variety of different form factors, including desktop and laptop configurations as well as embedded and headless forms.

Embodiments of the invention use a variety of motors and actuators, such as brushed or brushless DC motors, AC synchronous and induction motors, stepper motors, servomotors, solenoids, and/or pneumatic and hydraulic actuators. In an embodiment, computer system 800 include motor and actuator controls 1060 for providing power and control signals to these motors and actuators.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for assembling composite preforms, the method comprising:
setting a flexible membrane to a deformable state;
pressing the flexible membrane against a shaping surface to form a first forming shape;
setting the flexible membrane to a rigid state that retains the first forming shape; and
pressing the membrane in the rigid state with the first forming shape against a material layer to form the material layer into at least a portion of the first forming shape.

2. The method of claim 1, wherein a mold having a cavity includes the shaping surface.

3. The method of claim 1, further comprising:
resetting the flexible membrane to the deformable state;
applying the flexible membrane to a second shaping surface to form a second forming shape; and
setting the flexible membrane to the rigid state to hold the second forming shape.

4. The method of claim 1, wherein pressing the flexible membrane in the rigid state with the first forming shape against the material layer comprises applying heat to the material layer to assist forming the material layer into the first forming shape.

5. The method of claim 1, wherein the flexible membrane comprises a flexible material configured to hold at least a partial vacuum by preventing the passing of gas through the flexible material at a rate low enough to maintain the flexible membrane in the first forming shape during the pressing of the flexible membrane against the material layer.

6. The method of claim 1, wherein the flexible membrane is part of a chamber assembly comprising an upper support structure and a lower flexible portion including the flexible membrane.

7. The method of claim 6, wherein the setting the flexible membrane to a rigid state includes drawing a vacuum within the chamber assembly sufficient to compress shape resettable materials disposed within the chamber assembly together to hold the forming shape.

8. A apparatus for assembling composite preforms, the apparatus comprising:
an upper support structure;
a lower flexible portion coupled to the upper support structure;
wherein the upper support structure and lower flexible portion form a chamber therebetween configured to hold at least a partial vacuum; and
a shape resettable material disposed within the chamber, wherein the shape resettable material is configured to form a ridged body when compressed by the lower flexible portion and upper support structure in response to holding the at least partial vacuum.

9. The apparatus of claim 8, further comprising an upper portion coupled to the upper support structure and configured to couple a vacuum source to the chamber.

10. The apparatus of claim 8, wherein the lower flexible portion comprises a flexible membrane including at least one flexible material configured to hold the at least partial vacuum within a threshold rate of passing a gas.

11. The apparatus of claim 8, wherein the lower flexible portion is configured to form a pressing shape to press an article against a receiving surface during the at least partial vacuum.

12. The apparatus of claim 8, wherein the lower flexible portion is configured to form a material holding shape to hold an article during the at least partial vacuum.

13. The apparatus of claim 8, wherein the shape resettable material comprises granular materials configured to be held together by internal friction between the granular materials when compressed together by compression applied by the lower flexible portion and upper support structure to the granular materials during the at least partial vacuum.

14. The apparatus of claim 8, wherein the shape resettable material comprises interlocking materials configured to be held together by internal friction between the interlocking materials when pressed together by compression applied by the lower flexible portion and upper support structure to the interlocking materials during the at least partial vacuum.

15. A system for assembling composite preforms, the system comprising:
an upper support structure;
a lower flexible portion coupled to the upper support structure;
wherein the upper support structure and lower flexible portion form a chamber therebetween configured to hold at least a partial vacuum; and
a shape resettable material disposed within the chamber, wherein the shape resettable material is configured to form a ridged body when compressed together by the lower flexible portion and upper support structure in response to holding the at least partial vacuum.

16. The system of claim 15, further comprising an upper portion coupled to the upper support structure and configured to couple a vacuum source to the chamber.

17. The system of claim 15, wherein the lower flexible portion comprises a flexible membrane including at least one flexible material configured to hold the at least partial vacuum within a threshold rate of passing a gas.

18. The system of claim 15, wherein the lower flexible portion is configured to form a pressing shape to press an article against a receiving surface while under the at least partial vacuum.

19. The system of claim 15, wherein the lower flexible portion is configured to form a material holding shape to hold an article while under the at least partial vacuum.

20. The system of claim 15, wherein the shape resettable material comprises materials configured to be held together by internal friction between the materials when compressed together by compression forces applied by the lower flexible portion and upper support structure to the materials during the at least partial vacuum.
